(19) United States
(12) Patent Application Publication
(10) Pub. No.: US 2008/0174550 A1
(43) Pub. Date: Jul. 24, 2008

(54) Motion-Input Device For a Computing Terminal and Method of its Operation

(76) Inventors: Kari Laurila, Tampere (FI); Samuli Silanto, Helsinki (FI); Anssi Vanska, Helsinki (FI); Antti Virolainen, Helsinki (FI); Timo Pylvanainen, Tampere (FI); Juha Rakkola, Espoo (FI); Jukka H. Salminen, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/817,085

(22) PCT Filed: Feb. 24, 2005
(86) PCT No.: PCT/IB05/00466

§ 371 Date: Oct. 12, 2007

(51) Int. Cl. G06F 3/033

(52) U.S. Cl. 345/158; 455/41.2

(57) ABSTRACT

The invention relates to a motion-input device for a computing device, comprising a housing; a three-axis acceleration sensor arranged in said housing for outputting inertia signals related to the orientation and the movement of the motion-input device with a three-axis compass arranged in said housing, for outputting magnetic field signals related to the magnetic field orientation of the motion-input device, wherein said motion-input device is provided with a transfer component for transferring said magnetic field signals and said inertia signals to said computing device.

The present invention relates to a motion-input device for a computing device or computer terminal, especially to game pads for gaming applications, video game devices or game decks. By motion input the motion detection or sensing of motion is understood. The present invention further relates to the field of wireless motion-input devices or wireless game pads. The invention also relates to electronic gaming accessories. The invention is also directed to the rising trend to use real physical movements as interaction input for gaming.

The present invention is also related to the design of user interface components for very small handheld devices, which may be difficult to be used by traditional button-based controlling means because of small size restrictions of the actual device. The invention also relates to new movement detecting sensors implemented in a device and to new analysis techniques in the field of pattern recognition.

It is known to use wireless game pads or controllers for the well-known game-console systems of Cast-, Station-, Cube- or Box-configuration.

In the known applications a wired connection between the game deck and a game pad of conventional shape with input buttons and joystick elements is provided. These wireless game pads are often provided with a vibration function as a kind of haptic feed back. Other user-input devices known in the art are disclosed in the following documents:

US2003/0022716A1, US2005/0009605A1, EP0745928A2,
US2004/0227725A1, EP0373407B1, US6727889B2.

The document US20030022716A1 discloses a motion-input device for computer games provided with at least one inertia sensor and at least one trigger button. The device can use the signals from an inertia sensor to detect any kind of user input.

The document US20050009605A1 discloses an optical trackball provided with a joystick-like protrusion to serve as a joystick, i.e. uses an optical scanning device for detecting the position of a joystick or a wheel input device for gaming applications.

It is also known in the art to use an IR LED and a respective photo diode as the sensor for determining the position of a joystick, like disclosed in document EP0745928A2. This document discloses a control pad with two three-axis input devices permitting six-axis game play. The position sensor disclosed in EP0745928A2 uses parallel oriented light emitters and receptors to determine a distance to a reflective surface by determining the amount of light that can be detected at the receptor.

The document US200410227725A1 discloses a user controlled device, movable into a plurality of positions of a three-dimensional space, including a micro electromechanical systems acceleration sensor to detect 3D movements of the user controlled device. The device, such as a mouse, sends control signals correlated to the detected positions to an electrical appliance, such as a computer system. A microcontroller processes the output signals of the MEMS acceleration sensor to generate the control signals, such as screen pointer position signals and “clicking” functions.

The document EP0373407B1 discloses a remote control transmitter being provided with a positional-deviation switch configuration, which in the event of an angular deviation of the transmitter beyond a particular trigger angle from a particular given or instantaneously determined reference operating position generates an output signal designating the direction of the positional deviation. In the remote control transmitter, this direction-dependent output signal is converted as a control command into a transmission signal, and emitted via a transmitter element to a remotely controlled electrical appliance. By means of swivel movements of the remote control transmitter from the wrist of the user operating the remote control transmitter, different control commands to the remotely controlled appliance are generated in this way in the remote control transmitter.

U.S. Pat. No. 6727889B2 discloses a computer mouse-type transducer with a conventional mouse sensor and mouse functionality. In addition, a joystick is mounted on the mouse and activated by a palm-controlled treadle conjoined to the mouse via a ball and socket joint. The treadle may be pitched, rolled and, optionally, rotated, with each movement being transduced into a separately interpretable electrical signal. The mouse may include a suspension spring urging the treadle to an unloaded height. Depression of the treadle may be transduced by a switch to change modes of functionality. The mouse may have conventional mouse buttons or may be provided with rocker type buttons that can assume three states,

The documents disclosing input devices on the basis inertia sensors have only been implemented for orientation determination or movement determination. The above-cited documents do not disclose any gesture recognition for input.

Different game input devices are already known that allow a user to perform multidimensional input- and control commands.

All of the above cited acceleration or inertia based motion-input devices suffer from the inconvenience that any acceleration or inertia sensor cannot differentiate between heavy mass and inert mass. This fact that enables technicians to build highly accurate 3D simulators for flight and vehicle simulations, affects the measurement accuracy as no inertia sensor can determine a linear and constant movement (ref. inertial system). However, in case of a movement it is difficult to separate the accelerations caused by the movement of the motion-input device from the gravity acceleration vector, which renders the process computationally complex.

Additionally small handheld devices are difficult to be used because of their small size. It is for example difficult to find and press small buttons to activate specific functions, especially so if the usage environment requires some attention. It is therefore desirable to have new user interface concepts for small devices that may solve or at least ameliorate some of the small size button problems with novel input mechanisms.

In view of the different above cited state of the art terminal device and video game motion-input devices it is desirable to provide a further developed terminal device or video game motion-input device.

It is also desirable to provide a terminal device or video game motion-input device with increased detection accuracy.

It is also desirable to a have a terminal device or video game motion-input device provided with an increased resolution.

It is also desirable to a have a terminal device or video game motion-input device provided with an increased number of reference parameters.

It is also desirable to provide a wireless terminal device or video game motion-input device.

It is also desirable to have a new design of user interface components for very small handheld devices.

According to a first aspect of the present invention a motion-input device for a computing device is provided. Said motion-input device comprises a housing, a three-axis acceleration sensor, a three-axis compass and a data transfer component.

The housing of the motion-input device may be implemented as a handle shaped device for single hand operation, a ring shaped device for single hand or dual-hand operation (such a an armlet, a steering wheel or a hula hoop, or in from of a substantially “H” or “W” dual-hand input device such as a steering rod, or the like.

Said three-axis acceleration sensor is arranged in said housing for outputting inertia signals related to the orientation and the movement of the motion-input device. It this context the expressions “inertia sensor”, “accelerometer”, “acceleration sensor” and “gravity sensor” are used synonymously. According to the position of the three-dimensional acceleration sensor the sensors may detect an angular motion (e.g. when the acceleration sensors are located far from the axis of a pivoting axis) of the housing. The accelerometers can also be used to detect relative linear movement in 3D space by integrating the acceleration signals. The acceleration sensors are also subject to the acceleration of gravity so that the acceleration sensors may also indicate the direction of the gravity as an offset in case of a motionless input device. The acceleration of gravity is superimposed to the acceleration signals caused by an accelerated motion of the input device.

Said three-axis compass is arranged in said housing, for outputting magnetic field signals related to the orientation of the motion-input device. The three-axis compass or magnetometer provides a constant reference vector that is substantially independent of any transitions and accelerations of the motion-input device.

Said motion-input device is provided with a transfer component for transferring said magnetic field signals and said inertia signals to said computing device said motion-input device is intended for. The component for transferring said magnetic field signals and said inertia signals may rely on lead cable, glass fiber, transmitters like IR/Radio/ such as Bluetooth or WLAN.

The device may be used for any kind of computer device input and is suitable for video game console input for increasing the user experience enabling natural movements of the user. The input device of the present invention provides two independent motion sensors a 3-D accelerometer and a 3-D magnetometer for using real physical movement e.g. as input for gaming. In the static case both sensors just provide a static vector in the direction of gravity and of the magnetic pole. In the static case both sensors provide nearly redundant information. Except that it is expected that there is an angle between these two vectors. However, this angle allows it to fully determine the orientation of the device in space with relation to gravity and e.g. the (magnetic) North Pole. The sensor information in the static case is nearly redundant except of the angle between the reference vectors. However, in case of the motion, the acceleration vector is superimposed to any kind of acceleration acting on the input device. The 3D-compass sensor is not subjected to any kind of acceleration effect. This difference and the constant angle between the gravity vector and the magnetic vector can enable the device to count back the gravity vector from the acceleration sensor signal even if the input device is turned and/or linearly accelerated.

That is, the basic version of the motion-input device according to the invention enables 3 degrees of freedom (DOF) operation. Two degrees of freedom (DOF) result from the 3-D acceleration sensors (or tilt sensor). Additional two DOF are provided from the 3-D magnetometer that detects rotational movement (on a horizontal plane). However, as the 3-D acceleration sensor and the 3-D magnetometer share one degree of freedom, this results only in three degrees of freedom for the combination of the sensors. The device can determine the absolute orientation by detecting the gravity vector and the North direction.

In a basic raw implementation the motion-input device may be provided as a housing for a 3-D accelerometer and a 3-D magnetometer being provided with a cable (with a pair of leads per sensor dimension) to transfer the sensor signals to an external computer device for evaluation.

According to an another aspect of the present invention a motion-input device for a computing device providing five degrees of freedom for input is provided. The device comprises a three-dimensional orientation determination element and a joystick. The three-dimensional orientation determination element comprises acceleration and compass sensors, for providing three degrees of freedom of motion input individually or in combination. The joystick provides two additional degrees of freedom of input. The combination results in a total number of five degrees of freedom that are available. If the joystick is embodied as a finger or thumb joystick all five degrees of freedom for input are available in single-hand operation of said motion input device. The three-dimensional orientation determination element comprises acceleration and compass sensors. It is to be noted that the number of dimensionality of the acceleration sensor can assume any number between 1 and 3 (and in special case up to 6). It is also to be noted that the dimensionality of the compass sensor can assume any number between 1 and 3 (and is preferably 3). However, the addition of the dimensions covered by both sensors has to be at least 4 for simple evaluation of the values and to achieve full 3 degrees of freedom for input movements.

In an example embodiment said motion-input device is further provided with at least one gyro sensor. This embodiment can provide additional position and movement data according the to the actual (even constant) angular speeds. Conventional gyroscopes using rotating masses or piezo gyro sensors may implement this. This implementation has the advantage that the gyros can utilize the precession and the momentum of a rotating mass to determine angular speeds and accelerations.

In another example embodiment of the present invention said motion-input device is provided with at least one angular acceleration sensor. An angular acceleration sensor may be implemented as optical glass fiber gyro sensors based on signal frequency shifts difference, or on pivotably suspended masses wherein the mass center of the mass coincides with the pivot axis.

It is also contemplated to implement 3 conventional 2-D acceleration sensors arranged at the side surfaces of a triangle-based prism. This arrangement of angular acceleration sensors can serve as a combined 3D gravitation, angular acceleration and transitional acceleration sensor. A simpler implementation may be achieved by an arrangement of 6 one-dimensional inertia sensors at the centers of and parallel to the surfaces of a cube. The opposing sensors are to be oriented in parallel, and the planes defined by the opposing sensors are to be oriented orthogonal with respect to each other. In this configuration the inertia sensors can provide an additional information about the rotation acceleration and the transitional acceleration of the input device.

In another example embodiment said housing has the shape of an interchangeable memory card. This application is designed for memory card module based handheld game consoles such as the Nokia's N-Gage™. The main advantage is that the motion recognition capability can be retrofitted to existing portable consoles or into video game controllers provided with a memory card or “rumble pack” slot such as is known from “SEGA/Dreamcast™” controllers. This embodiment may also be provided with an onboard memory to provide game software (in addition to the orientation/motion detection sensors) to the mobile terminal. It is also envisaged to implement a processor in the memory card device to perform motion recognition tasks to relieve the restricted processing power of e.g. a mobile device from the task of recognizing motions and gestures. In this case the terminal can use its whole processing power for executing game software with maximum performance ensuring the richest possible gaming experience.

In another example embodiment said motion-input device further comprises at least one button input-device. In addition to the inertial and acceleration sensors, other forms of analogue or digital input (like buttons and switches) can be part of the device. The analogue or digital input buttons or switches can be arranged to four-finger or thumb operation. The buttons can also be provided to determine if the motion-input device is actually held in a hand or lying on a surface. A digital button comprises only two states on an off while an “analogue” button changes an output value with pressure applied. The buttons (or keys) may be implemented as direct input buttons or as e.g. selection buttons, wherein it is facile to access direct input buttons during normal operation, and selection or start buttons are usually located aside to prevent inadvertent activation during operation. Both input buttons and selection buttons may be implemented as analogue or digitally operating buttons.

This operation may be implemented by a sensor button detecting the presence of a user serving as a kind of “dead-man's safety system” to enter e.g. a sleep mode of the motion detection system, if the operator is actually not using the motion-input device. It is further to be noted that said transfer component is provided for transferring said button input signals also.

In yet another example embodiment said input device comprises at least one two dimensional joystick input device, protruding from said housing for providing a joystick signal.

With the joystick the motion-input device enables 5 degrees of freedom (DOF) operation, wherein 2 degrees are realized by the joystick operation and 3 degrees by rotation (and/ or superimposed translation movement) of the device on all 3D-axis.

Such joysticks for single finger operation are known for example from all actual standard game pads of commonly known video game console manufacturers. The joystick can be a finger- or thumb-operated joystick with an “analog” or digital operation. The joystick can be provided or implemented as a “coolie hat” or a 4 or 8 way rocker key. The joystick may be implemented in the shaft of the thumb- joystick that can be operated by pushing axially into the stick for additional user input options. The joystick may be implemented at the end of the housing arranged substantially axially for thumb operation. It seems necessary to mention that said transfer component is provided for transferring said joystick signals also.

In this embodiment the invention enables 5 degrees of freedom (DOF) operation with single hand. The traditional thumb joystick provides two degrees of freedom. Magnetometer and accelerometer together uniquely define the orientation of the device in 3D space, giving additional three degrees of freedom.

Especially for the 5-degrees of freedom input device several uses cases can be identified for example to replace traditional 2-joystick 2-handed game pad with single-handed device. Additionally, the orientation of the device is ideal for looking around and pointing into 3D space (like in games with first person view). The orientation of the motion-input device can be transformed into yaw, pitch and roll angles, which is ideal for flight and space simulations, Thus, the invention allows single-handed operation where normally two hands (or thumbs) and feet are required with traditional game pads. Refer to airplane controls: right hand on stick, left hand on throttle and feet on rudders. The invention also enables detection of complex 3D motion trajectories (3D accelerometer and 3D magnetometer), called gestures. Gesture detection can be used simultaneously with the above use cases.

In yet another example embodiment said motion-input device further comprises at least one trigger button input device. This kind control option is especially suitable for finger operated inputs such as throttle control for car driving simulations (such as known from slot cars) or for gun simulations or especially for warplane simulations.

In another example embodiment said motion-input device wherein said housing has substantially the shape of a handle. The housing can have the shape of a single-hand handle (i.e. a Joystick) or a combination of two single-hand handles i.e. a “H”, “W” or “O” shaped devices as known from the control elements of vehicles planes, or e.g. hovercrafts. In yet another example embodiment said motion-input device further comprises a housing in the shape that can be connected to or fastened to a body part or a garment of a user. This would enable a user to wear the motion input device e.g. in a hand, on the forearm, on the upper arm, on the head, on the chest, on the femoral, on the lower leg or on the foot. This may be implemented e.g. by a ring a strap or by a shackle. It is also envisaged to provide the motion input device with a fixation element to connect the device to a garment of a user for example by lacing or by Velcro fastening. This implementation would allow wearing the motion-input device on a glove, on a jacket, shirt or a pullover, on trousers or fastened to a cap, a helmet or a shoe of a user. The housing can comprise a collar, a chuff or a sleeve element to be connected to an arm, a finger, a foot, a leg or a shoe of a user. It is also envisaged to implement a number of holes to connect the motion-input device to lacing of a lace up shoe. It is also envisaged to implement an adapter element in the from of a gaiter. This implementation would be the end of foot operated input devices commonly known as “dance mats”, as the devices relieve a user from looking at his feet to hit the right areas on the mat. Additionally, the present invention can detect turns (and taps when connected to the feet) so that the device may be used as a dance choreography trainer.

A special advantage is that use of the invention is not limited to only hands, as one may connect a technically identical module to e.g. his feet, and thus create additional physical gaming interactions: E.g. playing with N-Gage and having wireless (BT) foot controllers to make the gaming experience richer. That is a user may use up to 5 independent input devices for a multidimensional game input, 2 (for each hand one), 2 (for each foot one) and 1 for the head. It is also envisaged (especially in case of feet mounted motion-input devices) to implement a dynamo or generator device into the input device to obtain (electrical) energy from the movement of the input device during gameplay.

In just another example embodiment said input device further includes a controller connected to said sensors, and other input devices in case that the device also comprises other input devices. The controller can be used to digitize or multiplex e.g. sensor data for transmission or for input to said computer device. It is also envisaged to multiplex e.g. the data from the additional input elements such as joysticks buttons triggers and the like. It is also contemplated to use the controller to perform a sensor signal preprocessing to transfer only orientation or position data to the computer device.

In another example embodiment of said motion-input device said controller is configured for recognizing predefined gestures as input from said obtained inertia signals and magnetic field signals. The measured movements of the device can identify gestures. Gesture recognition using the “Hidden Markov Model” (HMM) is for example a possible way of implementation. It is expected that the HMM for evaluating the acceleration sensor signals is quite different from the HMM uses for evaluating the magnetometer signals. The application of the HMM may be performed in quite different ways. It is for example possible to use a single HMM of all parameters provided by the sensors. It is also envisaged to implement a single HMM of all parameters obtained by the sensors and by the input elements.

In this embodiment the computation of the orientation, movements and gestures takes place in the processing unit within the input device, before the input is transmitted or provided to the computer device.

In yet another example embodiment said controller of said motion-input device is configured to use pre-processing and rotation normalization on said obtained inertia signals and magnetic field signals before applying said continuous HMM models. Compared to the above embodiment the motion detection and evaluation (e.g. gesture recognition) is done after preprocessing and rotation normalization in the wireless input device, so that an input signal is calculated in the motion-input device directly. That is, the HMM is not applied to the raw sensor data but is applied to preprocessed and rotation normalized data.

The preprocessing is performed to increase the accuracy of continuous HMM models for recognizing predefined gestures (made by handheld device) from accelerometer signal after specific steps on pre-processing and rotation normalization. This may be implemented by a matrix of D=(a₁, a₂, . . . , a_{T})^{T} containing the 3D acceleration vectors, wherein aᵢ is the acceleration measured at time tᵢ. A mapping function g_{T}(D) provides a linear mapping from the T×3 matrices to the R³ space, which estimating the direction of gravitation from the measured data. For example, g_{T}(D) can be the mean of the vectors aᵢ.

The gravitational component is always present in the gestures, and can be a significant source of information about the gesture. However, depending on the initial orientation of the hand, the gravitational component can be observed at different angles. For accurate recognition, however, the gravitational component should be around expected locations at different parts of the gesture. This can be achieved by rotating the data in D so that g_{T}(D)=c(1,0,0)^{T}, where c is some arbitrary constant. The effect of initial orientation of the hand is thus removed, and the direction of the orientation during the gesture should be only due to the way the gesture is performed.

Especially, in the case of a 3D magnetometer is present in the input device this magnetometer information may be used to perform this rotational normalization.

Because of the g_{T} is a linear Function, it is sufficient to find a rotation (or rotoinversion) matrix R such that Rg_{T}(D)=(1,0,0)^{T}. This can be done as follows. Let R=(r₁, r₂, r₃)^{T}, and r₁=g_{T}(D)/|g_{T}(D)|, r₂=y-proj(r₁, y)/|y-proj(r₁, y)|, r₃′=z-proj(r₂,z) and r₃=r₃′-proj(r₁, r₃′)/|r₃′-proj(r₁, r₃′)|. That is, use Gram-Schmidt orthogonalization procedure on the vectors g_{T}(D), y, z in that order, thus generating a new base for R³, where one of the base vectors is in the direction of the estimate for the gravitational component. Here is y=(0,1,0)^{T}, z=(0,0,1)^{T} and proj(u,v) is the projection of v on u. Since the vectors in R are orthonormal, it is clear that Rg_{T}(D)=|g_{T}(D)|(1,0,0)^{T}, and RTR=diag(1,1,1). The latter equality shows that R represents a rotation or rotoinversion.

Also for the HMM recognition to work the acceleration vectors at different parts of the gesture should be normally distributed around some mean trajectory. This fails when the gestures are done at different rates, since the magnitude of the acceleration is increased with the speed of the gesture. The data must therefore be normalized. A natural choice is to normalize so that the maximum observed magnitude is always 1, e.g. scale the data in D by 1/max{|aᵢ|}.

The HMM used is a left to right model, with transitions from each state to only itself and the following state. Each state has a single 3D multinormally distributed output, which directly represents the accelerations (after normalization as described above). The three dimensions are assumed to be independent, thus only diagonal elements in the covariance matrix are non-zero. Thus for n state model, there are 8 n parameters to be estimated: 3 expectation values and 3 variances for the output distribution and the 2 transition probabilities.

Given a number of examples of a gesture, the parameters for the model can be estimated by the Baum-Welch algorithm. Starting from some initial model, the idea is to compute the probability γᵢⱼ(t) of a transition from state I to state j at time t, given that the model generated the given training gesture. This can be done using Forward and Backward algorithms, described in most pattern recognition books (for example: Richard 0. Duda et. al, Pattern Classification 2^{nd} ed. Wiley-Interscience, 2001). After the statistics γᵢⱼ⁰^{ₖ}(t) for all training gestures Oₖ have been computed, improved estimates for the parameters for state I can be computed by the following formulas:

$${μ}_{i} = \frac{{\sum }_{k} {\sum }_{t = 1}^{{T}_{k}} {\sum }_{j} {γ}_{ij}^{{O}_{k}} ( t ) {O}_{k} ( t )}{{\sum }_{k} {\sum }_{t = 1}^{{T}_{k}} {\sum }_{j} {γ}_{ij}^{{O}_{k}} ( t )}$$

$${σ}_{i}^{2} ( l ) = \frac{{\sum }_{k} {\sum }_{t = 1}^{{T}_{k}} {\sum }_{j} {γ}_{ij}^{{O}_{k}} ( t ) {( {μ}_{i} ( l ) - {O}_{k} ( t ) )}^{2}}{{\sum }_{k} {\sum }_{t = 1}^{{T}_{k}} {\sum }_{j} {γ}_{ij}^{{O}_{k}} ( t )}$$

$${a}_{ij} = \frac{{\sum }_{k} {\sum }_{t = 1}^{{T}_{k}} {γ}_{ij}^{{O}_{k}} ( t )}{{\sum }_{k} {\sum }_{t = 1}^{{T}_{k}} {\sum }_{j} {γ}_{ij}^{{O}_{k}} ( t )} ,$$

wherein μᵢ(l) is the r1^{th} element of the expectation value (vector) for the output of state I, σ₁²(l) is the 1^{th} (diagonal) element of the covariance matrix and aᵢⱼ is the probability of transition from state I to state j. To restrict the model to left to right, with only transitions from the state to itself and the following state, it is sufficient to let the initial transition probabilities be zero for all other transitions. The new estimates given by the formulas will then always be zero, as they should, so there is no need to compute them.

The process is iterated from the beginning, by using the updated parameters to compute the statistics γᵢⱼ(t) and re-estimate the parameters.

After training the models, the recognition is done by normalizing the recorded data as with the training data, and computing the probability that each model generated the data. The model that gives the highest probability identifies the gesture. The probability of producing the data can be computed using the Forward algorithm.

Implementation can use standard methods (as known from speech recognition), such as using logarithmic probabilities instead of linear ones, to avoid problems with machine precision.

In another example embodiment said motion-input device further comprises an interface to a computing device connected to said controller. In a basic application a cable and a plug for sending the sensor and input element data to the computer device may implement this interface. In more sophisticated implementations the interface can connect the controller via a cable to the computer device to provide preprocessed multiplexed or compressed data to said computer terminal to achieve lower bandwidth for transmission. It is also possible to use a wireless interface. A cable interface has the advantage that the motion-input device may be provided with a power supply via the cable. However especially in case of a motion-input device a cable may restrict the freedom of movement if the cable connection is shorter than expected.

In yet another example embodiment said motion-input device said interface is an infrared interface and said interface device further comprises a power supply. In order to achieve wireless operation by using an infrared interface for transmitting the sensor and input element data, the device can be battery powered. However the use of IR has the main drawback that the device has to be provided with a large number of different IR transmitter diodes to enable a data connection from the movement input device to the computer device in any possible position and orientation.

In another example embodiment of said input device said interface is a radio interface and said interface device further comprises a power supply. The radio interface has the advantages of the wireless connection without the drawbacks of directed infrared radiation. Even low power radio devices with a range or a few meters are sufficient for a fully-fledged game input even if the input device is positioned behind the body of a user without losing the connection to the computer device (or game console). It is possible to implement a uni-directional radio connection or a bi-directional radio connection between the motion-input device and the computer terminal. It is also envisaged to implement a rechargeable battery pack into the wireless motion detection device, wherein as cradle can be used to serve as recharging station, a storage device and a “zero position reference point”.

In yet another example embodiment said interface is a Bluetooth interface. In order to achieve fail-safe wireless operation, the device can be battery powered and may use a digital wireless technology for transmitting the sensor data. A suitable technology for this is Bluetooth. Additionally and apart from the lower layer data transmission, Bluetooth specifies on a higher software layer the HID (human input device) which “defines the protocols, procedures, and features that shall be used by Bluetooth Human Interface Devices, such as keyboards, pointing devices, gaming devices, and remote monitoring devices.”

Especially the Bluetooth HID protocol sets up a suitable environment for input devices providing information on how the data to be transmitted may be coded to achieve a maximum of universal applicability.

This implementation provides a wireless (Bluetooth) single hand controlled action game pad, featuring buttons and joystick, as well as motion sensors (3D accelerometer and 3D magnetometer) for using real physical movements as gaming input.

In another example embodiment said motion-input device further comprises a feedback element. The feedback element can be connected to said controller (and/or at least to said interface) for receiving feedback signals from a connected computer (terminal) device. The feedback element can be provided as a haptic, an acoustic and/or a visual feedback element. It is for example possible to implement loudspeakers, mass actuators and LEDs or display elements in the motion input device to provide different feedback experiences. The visual feedback may be provided as an illumination pattern that may be indirectly perceived by a user looking at screen or a display. The visual feedback may be used to simulate the muzzle flash of a firearm in a game application. The device may also provide an acoustic feedback imitating the sound and of a firing gun in a first person shooter game (or the sound of a combination lock turned in a game application). A haptic feedback element can provide an impression of the recoil of a firearm e.g. in a hunting game application (or the feeling of a combination lock engaging in case of a sneaker game).

Haptic feed back may be categorized in two different principles a vibration feed back and an input element feedback. The vibration feedback may be implemented especially for feed back events strongly disturbing the input functionality such as a car hitting an object in a race game. The vibration feedback affects the motion detection and therefore the vibration effect may best be started in a situation wherein the input elements are blocked anyway, such as e.g. a stall in a plane simulation. The second type of haptic feedback can comprise additional input elements such as steering wheel forces or button press characteristics (such as e.g. emulating e.g. the trigger characteristics of a second set trigger). The haptic feed back of the input elements does not affect the primary motion detection by the 3D inertia sensors and the 3D magnetometer. Therefore, the input element action characteristics may be activated at any point in time during the input.

It is also possible to provide visual or acoustical feedback in the motion-input device. The feedback could be sent from the computing terminal or it could be calculated within the input device, thus avoiding the delays that are inherent in transmitting information to and from the computing terminal.

It is explicitly envisaged to implement the computation of the orientation, movements and gestures in the processing unit within the computer terminal for which the invention serves as an input device. This may achieve power saving at the motion-input device as it is expected that the host device is not a battery powered device.

In yet another example embodiment said input device wherein said feedback element is connected to and controlled by said controller according to said recognized input. That is the motion detection and evaluation (e.g. gesture recognition) is done in the wireless input device, so that user feedback can be calculated and provided in the device directly.

In another example embodiment said motion-input device further comprises a memory unit connected to said controller. The memory unit may be used as a memory device for storing e.g. input device settings such as e.g. personal key configurations, or external information such as game status in case of computer games.

If the controller of the device is powerful enough the embodiment can provide an autonomously operating motion-input device for providing input related feedback.

If the memory device is provided with application specific parameters on how to operate feedback actuators according to certain input, the motion-input device can operate autonomously. Based on the received input from any input element provided in the motion-input device the controller can control the feedback elements to generate feedback for different inputs/motions.

Such a system may be implemented in a gaming platform. The feedback device may be a force-feedback device, an audio output system or a display element, and the input elements can be used to detect any kind of input. This special embodiment of an onboard feedback generation is only suitable for input related force feedback. Any feedback output caused by e.g. a collision or received hits still have to be transferred in the conventional manner from the computer device.

The memory device enables to upload parameter sets for wireless game controller. The parameter set for feedback especially for haptic feedback allows the implementation of pre-programmed force feedback pattern for e.g. vibration feedback in games. These patterns are stored in the memory device or the controller. For example shot gun/machine gunfire, pump and slide in driving games etc. The controller or the computing device may activate the desired input feedback characteristics accordingly. For example a change of weapon would activate a new input feedback characteristic. The activation of input feedback characteristics in game controller can be done locally and automatically when e.g. a trigger is pressed or specific gesture is recognized.

According to another aspect of the present invention said motion-input device further comprises an element to constrain the motion of the input device. These elements to constrain the motion of the input device seem to be paradox, as the main advantage of the invention seemed to be to achieve a maximum in freedom of motion. The elements to constrain the motion of the input device may be implemented as hooks for rubber bands, holes or receptacles for weights (preferably non-magnetic weights) and/or gyroscopes to restrict pivoting motions (in two dimensions). With these constraints the present invention may also be used for training and rehabilitation applications. It is envisaged to implement a dumbbell implementation or golf, tennis, or squash implementation of such a motion-input device to achieve a maximum user experience and training effect. It is also envisaged to use the elements to constrain the motion of the input device as a generation means for powering the input device.

According to another example embodiment a computer device is provided that is intended to be controlled with a motion-input device according to the preceding specification. The computer device comprises a housing, a processing unit and memory device, as any conventional computer device. Additionally the device also comprises obtaining means for obtaining inertia signals and magnetic field signals both related to the orientation and the movement of a motion-input device, wherein said processing unit is configured to use continuous HMM models for recognizing predefined gestures as input from said obtained inertia signals and magnetic field signals and to convert said obtained inertia signals and magnetic field signals into executable input. In this computer device the computation of the orientation, movements and gestures takes place in the processing unit on the basis of raw or pre-processed sensor data, within the computer terminal for which the motion-input device of the preceding description serves as an input device. In a basic version the computer device may be connected to the motion-input device by a hardwired connection without any separable interface.

In an example embodiment of said computer device said obtaining means for inertia signals and magnetic field signals comprises an interface to a motion-input device according to one of the preceding specification. This embodiment allows a user to exchange or interchange a motion-input device according to will. In this configuration the computation of the orientation, movements and gestures can take place in the processing unit within the computer terminal. However it is envisaged to perform pre-processing and rotation normalization in the motion-input device.

In yet another example embodiment of said computer device said obtaining means for inertia signals and magnetic field signals comprises a three-axis acceleration sensor and a three-axis compass. That is this implementation represents a computer device (e.g. a game console) with a built in motion-input device. This is the point at which a motion-input device for example with a sophisticated controller with processing capability and the computer device with a built in motion-input device are no longer clearly distinguishable from each other. This combined computer device with onboard motion-input device may also comprise a graphic output interface to connect the computer device to a TV screen as a “one controller game console”. It is also contemplated to provide the combined computer device with onboard motion-input device also with a built-in display, to enable mobile and portable gaming.

It is explicitly emphasized that the combined computer device with onboard motion-input device may comprise all the input elements like joysticks, buttons, triggers, shoulder buttons, or wheels as discloses for the motion-input device alone.

In an example embodiment said computer device comprises a cellular telephone. Especially mobile phone devices with portable size and sophisticated power supply, displays and continuously increasing calculation power are predestined to be fitted with input device with a 3D-inertia or acceleration sensor and a 3D-magnetometer sensor for additional input options. The processing power of modem GSM and UMTS cellular phones could be sufficient to use a motion detection system even with a hidden markov model. However, this may not be necessary, as the input motions that are required for telephone input is subject to the restriction that a user must always be able to see and recognize the display content, This restriction significantly reduces the number of possible motion-input movements or gestures. However especially the 3D-magnetometer can be used to implement special spin-the-bottle (or better spin the cellular phone) games in mobile telephones. Another application could reside in a virtual combination lock that allows an access to secured data only after a number of different movements of the phone.

In yet another example embodiment of said computer device said processing unit is configured to use pre-processing and rotation normalization on said obtained inertia signals and magnetic field signals before applying said continuous HMM models. This application can be used if the device uses raw sensor data from built in or connected 3D-acceleration and 3D-compass sensors. The advantages of the preprocessing steps and the normalization have already been discussed in connection with the motion-input device, and are therefore not repeated at this point.

In an example embodiment said computer device is further provided with elements to constrain the motion of the computer device. The constrain elements can comprise fastening bolts or straps to fasten the computer device at a car seat or any other surface to prevent that the computer device can hit a hard object or an hard article and may be damaged. If the computer device is provided with an onboard motion-input device the implementations of constraint elements may comprise hooks and eyelets for fastening rubber bands, expanders or weights at the 3D-movement computer device to train certain movements of the user. This may comprise e.g. special devices for training a user the complex motions required for fly fishing, balancing golf or tennis.

According to another example embodiment of the present invention a method for generating input for a computer device is provided. The method comprises obtaining inertia signals and magnetic field signals, applying hidden markov models on said signals, for recognizing predefined gestures from patterns of said inertia signals and magnetic field signals, and obtaining an input signal when a predefined pattern has been recognized.

In an example embodiment said method further comprises performing rotation normalization operations on said obtained inertia signals and magnetic field signals before applying said continuous HMM models.

In another example embodiment method further comprises performing amplitude normalization operations on said obtained inertia signals and magnetic field signals before applying said continuous HMM models. Said amplitude normalization operations can be performed pre or post said rotation normalization operations. The advantages and implementations of normalizing operations have been discussed in the preceding specification and are therefore not repeated here.

In yet another example embodiment said method further comprises coding said input signal and transferring said coded input signal to a computer device. The coding may be performed according to arbitrary coding and transmission protocols such as e.g. the Human Interface Device Profile for Bluetooth transmissions. It is also possible to use a Bluetooth RF-COM connection. It is possible to connect game pads directly into PC over the RF-COM. It is also envisaged to use a DirectX interface in Windows to implement the software interface to a game application for interacting. This implementation requires software (or a respective coded hardware element) that converts COM port data to DirectX joystick data.

According to another aspect of the present invention a method for generating a force feedback output for a motion-input device is provided. Said method comprises obtaining inertia signals and magnetic field signals, applying hidden markov models on said signals, recognizing predefined gestures from patterns of said inertia signals and magnetic field signals, obtaining an output signal if a predefined pattern has been recognized, and mapping said output signal to a predefined force feedback output signal, and generating a predefined force feedback signal at said motion-input device according to said mapping function.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

Preferably the computer program and the computer program product are distributed in different parts and devices of the network. The computer program and the computer product device run in different devices of the network. Therefore, the computer program and the computer program device have to be different in abilities and source code.

According to yet another aspect of the present invention a communication network terminal device for executing simulated communication is provided. The terminal device comprises a detection module, a determination module, a storage, a communication functionality component and a generation module.

In the following, the invention will be described in detail by referring to the enclosed drawings in which:

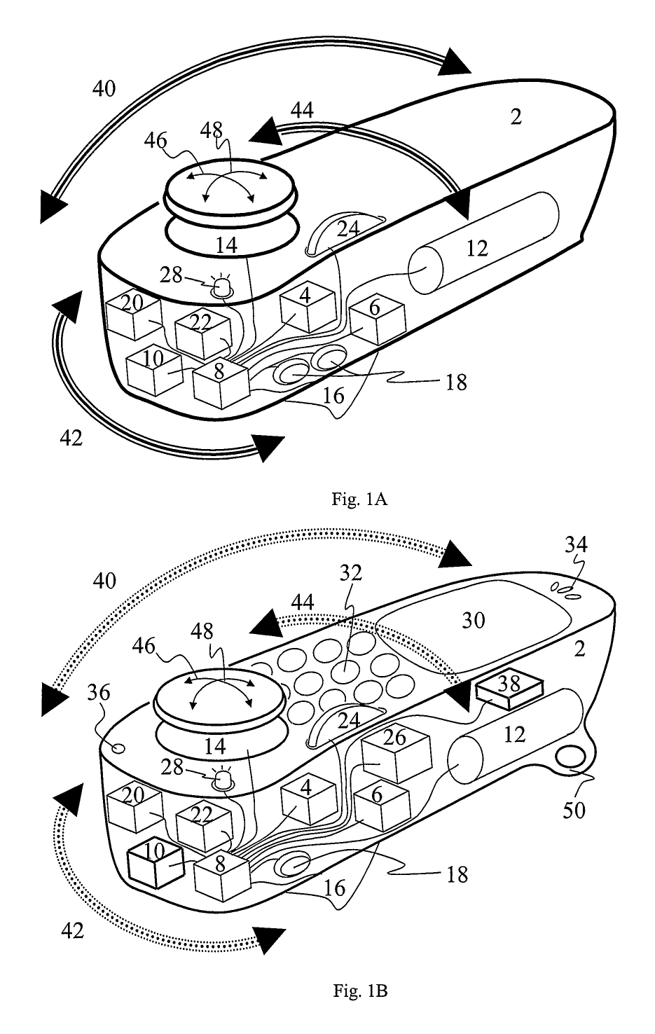

FIGS. 1A and 1B show different implementations of a motion-input device according to one aspect of the present invention,

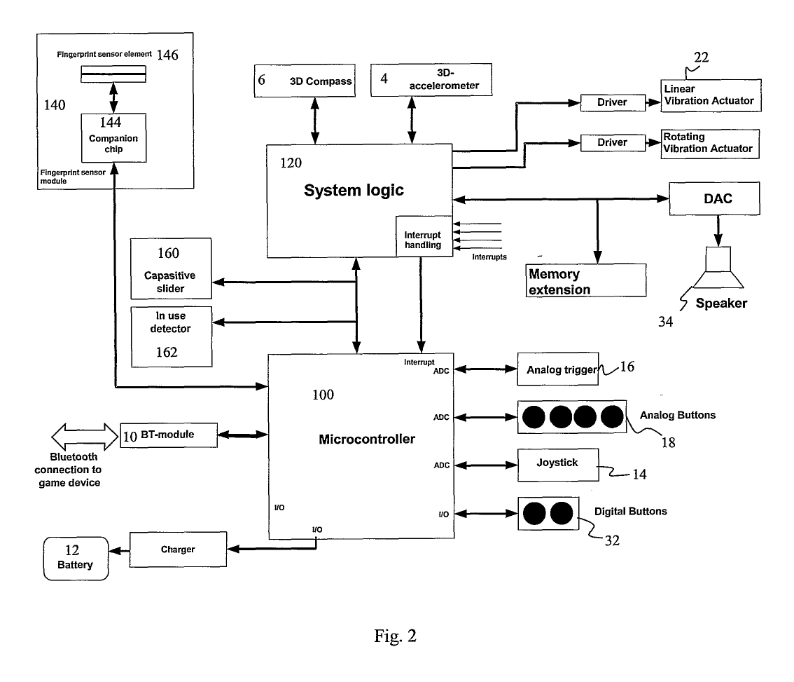

FIG. 2 is a block diagram of an example embodiment of a motion-input device according to the present invention,

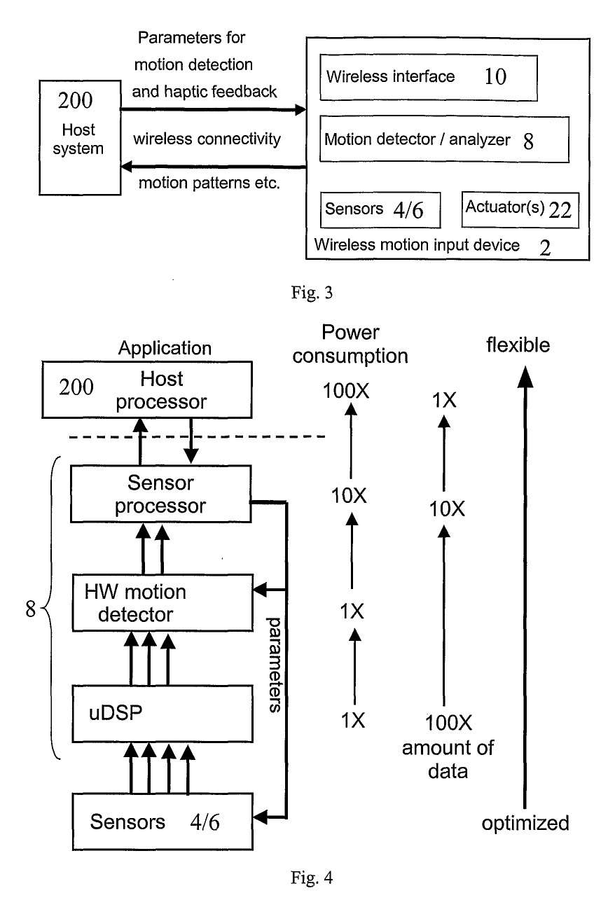

FIG. 3 shows an architecture of a motion-input device with a built in motion detector analyzer,

FIG. 4 is a diagram indicating the data flow and the energy consumption of the device of FIG. 3,

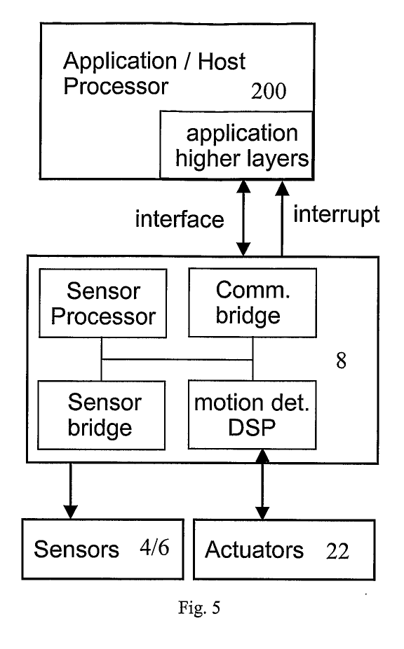

FIG. 5 shows a hierarchical sensor signal processing system diagram,

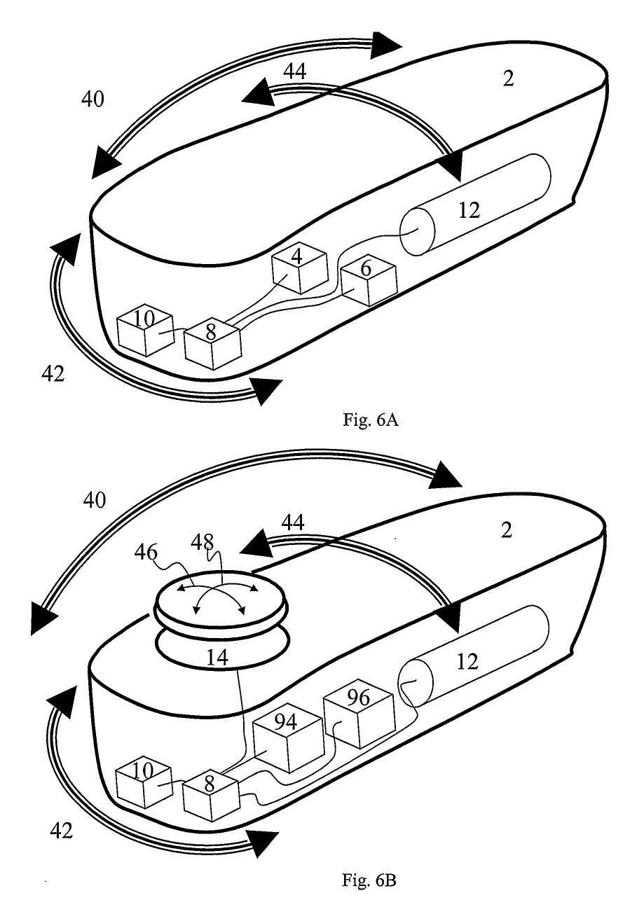

FIGS. 6A and 6B show different basic implementations of a motion-input device according to aspects of the present invention, and

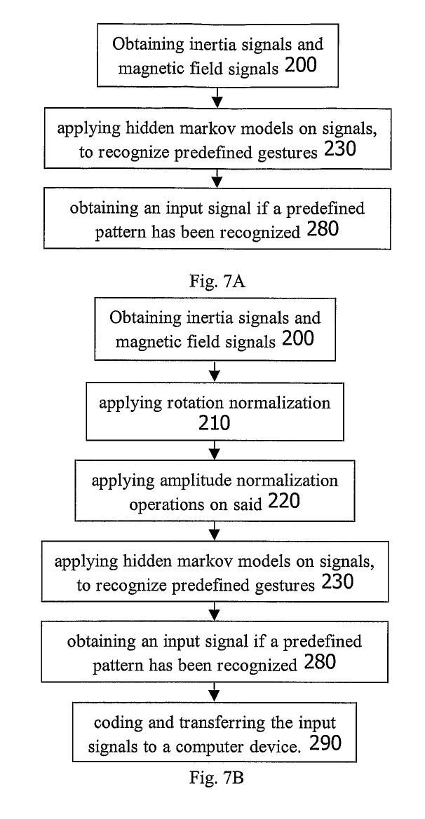

FIGS. 7A and 7B show block diagrams of a method of the present invention,

In the detailed description, which follows identical components have been given the same reference numerals, regardless of whether they are shown in different embodiments of the present invention. The drawings may not necessarily be to scale and certain features are shown in somewhat schematic form in order to clearly and concisely illustrate the present invention.

FIG. 1A in shows the main hardware elements in the motion-input device. The motion-input device hardware consists of a microcontroller 8 that communicates and analyzes the data from the accelerometer 4 and magnetometer 6 sensors. The microcontroller 8 handles also the communication to Bluetooth module 10 and any extra sensors 14, 16, 18, and 24 that can be integrated in the game pad. States of the traditional thumb joysticks 14 and analog/digital buttons 18 are read by the microcontroller 8.

Several communication modes can be programmed in controller 8 as well as different power saving modes. Also tactile feedback actuators 22 (and speakers) are supported in the motion-input device.

The primary acceleration detected by the 3D accelerometer 4 is caused by gravity. This allows for straightforward determination of the tilting of the device 2. For tilting determination it is sufficient to observe the values on the two horizontal axes of the accelerometer 4, which are orthogonal to gravity when the device is held straight.

A 3D accelerometer 4 combined with a 3D magnetometer 6 can be used for determining the exact orientation of the device with respect to earth reference coordinate system. D=└dₓ d_{y} d_{z}┘ is used as the matrix formed by the (unit) axes of the device. The three values from the 3D accelerometer 4 are projections of the gravity on the three axes of D, i.e., accelerometer 4 returns the vector α′=−D^{T}g. g is in the direction of negative y-axis in the earth reference coordinate system. The 3D-magnetometer 6 returns b′=D^{T}b, where b is generally pointing due (magnetic) north (or magnetic south) (z-axis of the reference coordinate system).

It is expected that the projections x′, y′ and z′ of the reference axes x, y and z on D are known. In the reference coordinate system the matrix E =[x y z] is the identity matrix, so D^{T}=[x′y′z′]. Now

$${y}^{′} = \frac{{a}^{′}}{\vert {a}^{′} \vert} .$$

Because D is orthonormal, y and z of length one and b is in yz-plane we have

$${x}^{′} = {D}^{T} ( y \times z ) = {y}^{′} \times {z}^{′} = \frac{{a}^{′} \times {b}^{′}}{\vert {a}^{′} \times {b}^{′} \vert} .$$

Finally z′=x′xy′ and D is determined and with that the orientation.

Further filtering is required because the accelerometer measures true acceleration not only the gravity. Also in parts of the world the angle between g and b can be very small and x′ as a cross product of the two can be very sensitive to noise. Low pass filtering gives some improvement already. It is also possible to discard measurements where the magnitude of g′ differs from expected or the angle between g and b is incorrect. These situations indicate true acceleration of the device and it is thus impossible to determine the orientation on the basis of a set of data at one point in time. In case of accelerated movement situations the accelerometers indicate true accelerations of the device and it is possible to determine the movement from an integration of the acceleration values over the time. In this case only acceleration components around in the direction of the magnetic field vector and rotations around the magnetic field vector may not be determined.

The matrix manipulation operations necessary to determine the orientation are intensive enough to require a relatively powerful CPU. Thus it makes sense to do the computations in the receiving end, rather than in the motion-input device itself. This makes the motion-input device lighter and extends the battery life of the battery in the motion-input device, especially if the receiving computer system does not rely on battery power.

There are also several ways to map gestures and orientation data to traditional game controller commands, which are accepted by game consoles on the market. A middle component, which is powerful enough to do the matrix arithmetic, can also do this mapping.

Such a middle component can include a much better interface for configuring the mapping than the game pad could.

Yet one more advantage is that more than one motion-input device can be connected to a single computing unit. This allows in the case of game controllers that commands can be dependent on the motion of more than one controller. This can be an exciting coordination challenge for the player, if he uses two of the motion-input devices, each in one hand.

The depicted motion-input device 2 has a substantially handle or bar type housing and is provided with a 3D-acceleration sensor 4 and a 3D-magnetometer 6 (or a 3D compass) which are both connected to a controller 8. The motion-input device 2 is further provided with conventional input elements such as a joystick 14, a trigger button 16 a digital or analog buttons 18 and a slider or wheel 24 all connected to and interrogated by said controller 8. It is also contemplated to implement an embodiment provided with multiple buttons for example 4 buttons instead of the joystick. In FIG. 1 there are also provided a feedback element implemented as a force feedback element 22 to provide feedback on input elements.

The controller 8 is provided to prepare the data and information received from the sensors 4, 6 and the input elements 14, 16, 18, 24 for transmission to a computer device (not shown). The controller 8 can send any kind of data (raw sensor data, preprocessed sensor data or recognized gestures or movements as input) via an interface module 10 (here implemented as a Bluetooth module).

The controller 8 is also connected to memory device 20 that may be interchangeable or built in. The memory device can serve as storage for transmission codes, feedback algorithms, preprocessing algorithms, gesture recognition algorithms, and/or sensor interrogation schemes. The controller is also provided with an indication light or LED 28 to inform the user about e.g. battery status, field strength, controller load or even computer program data such as e.g. a proximity sensor functionality in a computer game.

In FIG. 1B the input device is also provided with a cellular telephone with a display 30, an ITU-T keypad 32, a loudspeaker or earpiece 34, a microphone 36, and a processing unit 38. For the sake of clarity the connections between these elements and other telephone components known in the art has been economized. A connection between processing unit 38 of the telephone and the controller 8 is provided. It is also intended that the mobile phone can be controlled by a 3D-accelerometer and 3D magnetometer data received via said connection to said controller 8 to said processing unit 38 of the telephone. The device of FIG. 1B is also provided with a 3D-gyro or an angular acceleration sensor 26. A gyro or an angular acceleration sensor would allow completely tracking of the motions of the input device in a 3D space. The device of FIG. 1B is also provided with an element 50 for constraining the motion of the device. The element for constraining the motion of the device is embodied as an eye to connect a weight, a rubber band or any other motion-restricting device to the housing to achieve a training effect for different sport applications. The element 50 for constraining the motion of the device may also be used to fasten the device at a shoe, a racket a bat or e.g. a fishing rod for movement and trajectory analysis.

It should be clear, that the 3D-accelerometer data and the 3D-magnetometer data used to control the processing unit 38 may also be received via said interface module 10 (e.g. from the device depicted in FIG. 1A. In this role the device of FIG. 1B represent an implementation of a computer device to be controlled by a received motion-input device sensor. It is also possible to use the device depicted in FIG. 1B as a motion-input device for controlling a computer device such as e.g. a video game console being provided with a respective interface because the device also comprises all components also included in FIG. 1A. That is, the device depicted in 1B can serve as a motion-input device as the one depicted in FIG. 1A (if the telephone components are disregarded). The device depicted in 1B can serve as a computer device that can be controlled by a connected motion-input device (if the sensors 4, 6 and 26 and the telephone components are disregarded). The device depicted in 1B can serve as a computer device with a built-in motion-input device for performing inputs (if the telephone components are disregarded). The device depicted in 1B can also serve as a mobile telephone with a built-in motion-input device for performing inputs (if the interface 10 is disregarded).

FIG. 2 is a block diagram of an example embodiment of a motion-input device according to the present invention. The diagram comprises elements corresponding to the device depicted in FIG. 1. In contrast to the embodiment of FIG. 1 the controller comprises two elements the microcontroller with the reference sign 100, and the field programmable gate array system logic 120 which may also be implemented inside the microcontroller as software. The motion-input device is additionally provided with a capacitive slider module 160 an in-use detector 162. The motion-input device can also be provided with a general fingerprint sensor, which may be implemented e.g. as a daughter board 140 with a fingerprint sensor 146 and a comparison chip 144. The motion-input device is additionally provided with a charger module between the microcontroller 100 and the battery 12. The memory module is embodied as a memory extension module. The force feedback 22 is provided as a linear vibrating element or actuator and a rotation vibration element or actuator. The motion-input device is additionally provided with a digital to analog converter DAC for controlling a speaker 34.

The in-use detector may be implemented by a Fast Fourier Transformation (FFT) component analyzing the sensor signals for a constant frequency in the range of 50 to 210 Hz with a characteristic waveform. If a user holds the device in his hand, the device may detect small motions or accelerations caused by the heartbeat of the user. The pattern of this oscillation is quite characteristic and ma be obtained by applying a highpass or a bandpass filter and a FFT or a HHM function to the sensor signals to determine if the device is held in hand or not. However, it is also possible to implement the in use detector as a sensor button to detect the presence of a hand of a user by the skin resistance of the hand holding the motion-input device.

FIG. 3 shows an architecture of a motion-input device with a built in motion detector analyzer. In FIG. 3 the controller 8 also serves as a motion detector/analyzer to pre-recognize motions and gestures according to the signals received from the sensors 4/6. The main advantage resides in that the amount of data to be transferred is significantly reduced in as if the raw sensor data of a 3D-acceleration sensor and a 3D-compass sensor (and maybe the data of a 3D-gyro sensor) are to be transferred to the host device 200 as input. Another advantage of this architecture resides in the fact that the motion-input device may evaluate the sensor data to directly control feedback actuators 22 in the motion-input device. This has the advantage that (e.g. haptic) feedback signals do not need to be transferred from the host device to the wireless motion-input device 2. As the input for different applications on said Host system may require different evaluation algorithms of the sensor data and different feedback characteristics, the host system may transfer parameters for motion detection and feedback for the actuators 22 to the wireless motion-input device.

The system in FIG. 3 shows an autonomously operating motion-input device. The host system 200 sends application specific parameters over wireless link to motion detector. These parameters are used to configure the motion detector 8 (implemented as a part of the controller 8 in the other figures) in the wireless input device. After motion detector 8 has received parameters it can operate autonomously. Based on the results of motion detection process it can directly control the actuator device(s) 22 to generate feedback for different motions. Autonomously operating motion detector can also send information elements describing motion patterns it has detected to host system 200 wirelessly.

The example of such a system could be a gaming platform. In the gaming system the “host system” would be a game device and the “wireless device” would be a wireless game controller. The actuator would be a force feedback device and an accelerometer could be used to detect motion.

The benefits of this system setup are low power operation: no need to continuously send raw sensor data over the wireless interface, This results in huge power savings since a lot of power would be consumed in the RF interface. The preprocessed information elements would be sent instead (huge compression of information). Additionally fast feedback times can be achieved. Because the autonomous motion detector can directly control the actuator(s) 22. Sending information to host system 200 and then receiving control data from host system 200 would result in big latency, which in most cases would be too big. However this application is only suitable for input related force feedback.

An uploadable parameter set for wireless game controller enables the implementation of a universal codebook for gesture recognition. Game controller (2) returns quantisized gesture pattern to the host system 200. Quantization is performed in game controller (2) using the upload codebook.

The parameter set for feedback especially for haptic feedback allows the implementation of pre-programmed force feedback pattern for vibration feedback in games. These patterns are stored in game controller (2), For example shot gun/machine gunfire, pump and slide in driving games etc. The host device 200 will activate relevant patterns according to game situations. For example a change of weapon activates a new pattern. The activation of feedback pattern in game controller can be done locally and automatically when trigger is pressed or specific gesture has been recognized.

This principle is also applicable to fitness/activity monitoring and logs, to a sensor signal pre-processor in the phone for enabling motion-input and wireless sensors.

FIG. 4 is a diagram indicating the data flow and the energy consumption of the device of FIG. 3. In the framework of the present application the sensor processor, the hardware motion detector and the micro digital signal processing circuit are part of or allocated to the controller 8. In this figure the μDSP block takes care of low level signal processing needed for sensor signal filtering, calibration, scaling etc. This DSP block can be implemented using fixed logic but better flexibility and re-usability can be obtained by using simple DSP processor built around MAC (multiply and accumulate logic). This DSP executes simple micro-code instructions using a very small code memory. The power consumption of such a very simple DSP core is very low.

The filtered and calibrated sensor signals are fed to hardware motion detector. This highly optimized and thus very low power consumption motion detector takes care of less complex motion detection tasks including:
Detection of motion exceeding set threshold and of stillness,
Counting motion events, and
Continuity detection of parameterized continuous movement.

When there is movement the motion detector can wake up sensor processor to perform more advanced motion detection and analysis. But for the rest of the time upper layers of signal processing can remain in idle to state to save power.

Motion detector can simultaneously and parallel detect motions that are described different parameter values. For example it can detect motions in different frequency bands.

In this system the Sensor Processor is a small processor core that can be programmed using standard programming languages like C. This processor can be standard RISC, or processor that is optimized for specific application (ASIP, Application Specific Instruction set Processor). Sensor processor takes care of more advanced and more complex motion detection and sensor signal processing tasks. Sensor processor has low latency access to motion detector and sensor to effectively respond motion events. It also offers flexibility of full programmability of algorithms that are too complex to be implemented using fixed hardware. Sensor processor is also low power optimized (small size, compact code and remains in idle state for the most of the time).

Sensor processor low power operation is achieved by:
Using energy efficient low complexity processor or application specific architecture (ASIP).
Small software code size resulting in small program memory requirements and no caches or complex memory management.
Using low clock frequencies (about 1 MHz), wherein the frequency can be scaled according to the actual processing needs.
Heavy universal operating systems and context switching in operating systems is not required.
Using power saving modes controlled by a hardware motion detector.
And by buffering of sensor data, wherein the sensor processor processes buffered data blocks and not every single piece of data.

FIG. 5 shows a hierarchical sensor signal processing system diagram.

It shows a host processor 200, connected via an interface to a controller 8 with the components communication bridge, sensor processor, sensor bridge and motion determination DSP (digital signal processing). The controller 8 is connected to sensors 4/6 and to actuators 22.

The power consumption of sensor processing system is less than 1 mW at high activity and less than 0.1 mW at low activity as waiting for movement to be detected.

The following table shows the power consumption when a dedicated sensor processor is analyzing movement.

| Block | Power |
|---|---|
| Processor core running at 1 MHz* | 200 μW/MHz = 200 μW |
| Program memory 64 kB | 60 μW |
| Data memory 8 kB | 10 μW |
| Other digital functionality | 40 μW |
| Total | 310 μW |

The next table shows the power consumption when a dedicated sensor processor is waiting for a movement to be detected. The Sensor processor can be waked up from this state very quickly.

| Block | Power |
|---|---|
| Processor core off | 0 μW |
| Program memory 64 kB off | 0 μW |
| Data memory 8 kB off | 0 μW |
| Other digital functionality | 40 μW |
| Total | 40 μW |

When sensor processor detects motion pattern or movement described by set of parameters set by the application it can transfer a data element describing that motion/movement to the host processor as a message. The host processor runs the applications on top of a complex operating system, which makes it unresponsive to fast events and also consumes order of magnitude more power than much less complex sensor processor. Using data preprocessing on the sensor processor results improves the power efficiency and system responsiveness.

The host processor can remain idle while sensor processor is monitoring movements. This is important for applications needing continuous tracking of movement. Fitness monitoring device is an example of such application.

Host processor can take care of managing parameters for different applications. It sends these parameters for currently active application to sensor processor, which then configures and controls sensors and motion detector accordingly,

In this system host processor can have wireless connection to sensor processor. In this kind of setup it would be even more beneficial to be able to compress information before it is send over wireless link. The sensors produce relatively high data rates. For example a 1 kHz sample frequency results in a data rate of 48 kbits/second for all three accelerometer axes.

FIG. 6A shows a basic implementation of a 3D-motion-input device according to the present invention. FIG. 6A shows the main hardware elements in the motion-input device. The motion-input device hardware consists of a microcontroller 8 that communicates and analyzes the data from the 3D-accelerometer 4 and the 3D-magnetometer 6 sensors. The microcontroller 8 handles also the communication to an interface module (here a Bluetooth module) 10. In FIG. 6A there are no extra sensors integrated in the input device. In this basic implementation the motion-input device provides three degrees of freedom for motion input.

FIG. 6B shows another basic implementation of a 3D-motion-input device according to the present invention indicating the main hardware elements of the motion-input device. The motion-input device hardware comprises a microcontroller 8 that communicates and analyzes the data from the three-dimensional orientation determination element comprising accelerometer 94 and magnetometer 96 sensors. The microcontroller 8 handles also the communication to Bluetooth module 10 and the status/angles of the traditional thumb joysticks 14.

The three-dimensional orientation determination element comprises the accelerometer 94 and a magnetometer 96 sensors. In contrast to the figures the accelerometer 94 and a magnetometer 96 sensors may be only able to provide less than 3 dimensions each. In the depicted embodiment the three degrees of freedom of motion input are provided individually or in combination by acceleration and compass sensors. It is in this embodiment possible to combine e.g. a 2D compass and a 2D accelerometers as the basic sensors for detection a motion. This combination would enable an input device to detect (in case of a horizontal 2D accelerometer) straightforward determination of the tilting of the device 2. Additionally, (in case that the tilting angles do not exceed more than e.g. 30°) the 2D compass could detect the orientation with respect to north as the third degree of freedom for user input. As the moveability of the right hand is restricted to an angular range of approximately 135° to the left and 45° to the right (roll), 70° forward and 20° backwards (pitch) and 70° to the left and 40° to the right (yaw), this implementation would be sufficient for normal motion input.

FIG. 7A shows a block diagram of a method of the present invention. The method generates an input for a computer device. The method can be executed in a motion-input device itself or in a connected computer device. The method starts with obtaining 200 inertia signals and magnetic field signals. Then hidden markov models are applied 230 on said signals, to recognize predefined gestures, from patterns of said inertia signals and magnetic field signals. In this context the expressions “inertia signals” and “magnetic field signals” are to be understood as electrical signals (analog or digital) that are obtained from acceleration or magnetometer sensors. In analogy to the disclosed devices it may be necessary to mention that these signals may be 3D inertia signals and 3D-magnetic field signals. It is also envisaged to implement devices using 6D inertia signals (3D Cartesian coordinates and the respective 3D angles) and 3D-magnetic field signals. When the hidden markov models applied 230 on said signals that result in recognized predefined pattern an input signal is obtained 280 on the basis of said recognized pattern. This may be achieved by e.g. a lookup table.

FIG. 7B is the block diagram of FIG. 7A extended by the steps of applying rotation normalization operations 210 and applying amplitude normalization operations 220 on said obtained inertia signals and magnetic field signals before applying said continuous hidden markov models 230. It is also envisaged to apply the amplitude normalization operations 220 before said rotation normalization operations 210. After the application of a hidden markov model, the obtained input is coded and transferred 290 as a coded input signal to a computer device.

It seems also to be remarked that the present invention provides an electrical device provided with magnets and electric currents causing interfering magnet fields. However the interference effects may be eliminated by the use of correction parameters for deducting the interfering effect. In the magnetic sensor may by compensated against internal (i.e. fix to the device) magnetic fields by applying compensation parameters. Additionally, the magnetic sensor may by compensated against external (i.e. fix to the environment of the device) magnetic fields by applying compensation parameters that may be determined by a calibration operation which may include a null balance and a movement of the motion input device in all directions.

The advantages of hierarchical motion detector are:
A reduced power consumption by optimal partitioning of computing resources, while offering flexibility at the layers where they are needed. Other layers can be optimized for low power consumption.
Reduced power consumption by preprocessing and compressing information before it is sending it to higher-level processing elements.
Enables continues processing of sensor information with high energy-efficiency.
Improved system responsiveness by using local control if higher layers of processing resources are not needed.

In summary the present invention allows a single-handed usage in situations where typical gaming pads or joysticks require two handed input and/or foot pedals for using 3 and up to 6 degrees of freedom. The invention offers single hand operation, wireless connectivity and embedded motion sensors, which are ideally supporting the use of real physical movements in gaming.

The motion-input device of the present invention can be used to replace traditional 2-joystick 2-handed game pad with single-handed device. The orientation of the device is ideal for looking around and pointing in 3D space. Especially in games with first person view the sensor data can be used to move and a joystick signal can be used to look around. The orientation of the motion-input device can be transformed into yaw, pitch and roll angles, making it ideal for flight and space simulators. Thus the invention allows single-handed operation where normally two hands (or thumbs) and feet (or two extra fingers for shoulder keys) are required with traditional game pads. Refer to airplane controls: left hand on stick, right hand on throttle and feet on rudders. The invention also enables detection of complex 3D motion trajectories (/3D accelerometer and 3D magnetometer), to recognize gestures. Gesture recognition/detection can be used simultaneously with the aforementioned use cases.

Additional the invention enable the use of more complex 3D motion trajectories in gaming interaction without the need for camera devices, or floor placed input devices such as dance mat accessory. The present invention enables similar motion-inputs in gaming in a location independent way.

This application contains the description of implementations and embodiments of the present invention with the help of examples. A person skilled in the art will appreciate that the present invention is not restricted to details of the embodiments presented above, and that the invention can also be implemented in another from without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Motion-input device for a computing device, comprising:
a housing;
a three-axis acceleration sensor arranged in said housing for outputting inertia signals related to the orientation and the movement of the motion-input device,
characterized by a
a three-axis compass arranged in said housing, for outputting magnetic field signals related to the magnetic field orientation of the motion-input device,
wherein said motion-input device is provided with a transfer component for transferring said magnetic field signals and said inertia signals to said computing device.

2. Motion-input device for a computing device providing five degrees of freedom for input, comprising
a three dimensional orientation determination element, providing three degrees of freedom of motion input individually or in combination by acceleration and compass sensors, and
a joystick, providing two additional degrees of freedom of input.

3. Motion-input device according to claim 1 or 2, further comprising: at least one gyro sensor.

4. Motion-input device according to claim 1, 2 or 3, further comprising: at least one angular acceleration sensor.

5. Motion-input device according to anyone of the preceding claims, wherein said housing has the shape of an interchangeable memory card.

6. Motion-input device according to anyone of the preceding claims further comprising:
at least one button input element.

7. Motion-input device according to anyone of the preceding claims further comprising:
at least one two-dimensional joystick input element, protruding from said housing for providing a joystick signal.

8. Motion-input device according to anyone of the preceding claims further comprising:
at least one trigger button input element.

9. Motion-input device according to anyone of the preceding claims, wherein said housing substantially has the shape of a handle.

10. Motion-input device according to anyone of the preceding claims, wherein said housing is shaped to be connected to a body part or a garment of a user.

11. Motion-input device according to anyone of the preceding claims further comprising:
a controller connected to said sensors and said transfer component.

12. Motion-input device according to claim 11, wherein said controller is configured to use continuous hidden markov models for recognizing predefined gestures as input from said obtained inertia signals and magnetic field signals.

13. Motion-input device according to claim 12, wherein said controller is configured to use pre-processing and rotation normalization on said obtained inertia signals and magnetic field signals before applying said continuous hidden markov models.

14. Motion-input device according to anyone of the claims 11 to 13, further comprising:
an interface to a computing device connected to said controller.

15. Motion-input device according to claim 14, wherein said interface is an infrared interface and said motion-input device further comprises a power supply.

16. Motion-input device according to claim 14, wherein said interface is a radio interface and said motion-input device further comprises a power supply.

17. Motion-input device according to claim 16, wherein said interface is a Bluetooth interface.

18. Motion-input device according to anyone of the preceding claims, further comprising a feedback element for providing haptic, acoustic and/or visual feedback.

19. Motion-input device according to claim 18 as far as being dependent of 11, wherein said feedback element is connected to and controlled by said controller according to said recognized input.

20. Motion-input device according to anyone of the claims 11 and 12-19 as far as being dependent of 11, further comprising a memory unit connected to said controller.

21. Motion-input device according to anyone of the preceding claims, further comprising elements to constrain the motion of the input device.

22. Computer device for being controlled with a motion-input device according to one of the preceding claims,
said computer device comprises
a housing,
a processing unit, in said housing
a memory device, connected to said processing unit
characterized by
obtaining means for obtaining inertia signals and magnetic field signals both related to the orientation and the movement of said motion-input device, and
wherein said processing unit is configured to use continuous hidden markov models for recognizing predefined gestures as input from said obtained inertia signals and magnetic field signals and to convert said obtained inertia signals and magnetic field signals into executable input.

23. Computer device according to claim 22, wherein said obtaining means for inertia signals and magnetic field signals comprises an interface to a motion-input device according to one of the claims 1-21.

24. Computer device according to claim 22 or 23, wherein said obtaining means for inertia signals and magnetic field signals comprises a three-axis acceleration sensor and a three-axis compass in said housing.

25. Computer device according to claim 22, 23, or 24, wherein said computing device comprises a cellular telephone.

26. Computer device according to claim 25, wherein said processing unit is configured to use pre-processing and rotation normalization on said obtained inertia signals and magnetic field signals before applying said continuous hidden markov models.

27. Computer device according to anyone of claims 22 to 26, further comprising elements to constrain the motion of the computer device.

28. Method for generating an input for a computer device, comprising
obtaining inertia signals and magnetic field signals,
applying hidden markov models on said signals, to recognize predefined gestures from patterns of said inertia signals and magnetic field signals, and
obtaining an input signal if a predefined pattern has been recognized.

29. Method for generating an input for a computer device according to claim 28 further comprising:
applying rotation normalization operations on said obtained inertia signals and magnetic field signals before applying said continuous hidden markov models.

30. Method according to claim 28 or 29 further comprising: applying amplitude normalization operations on said obtained inertia signals and magnetic field signals before applying said continuous hidden markov models.

31. Method according to anyone of claims 28 to 30 further comprising:
coding said obtained input signal and
transferring said coded input signal to a computer device.

32. Method for generating an force feedback output for a motion-input device, said method comprising
obtaining inertia signals and magnetic field signals,
applying hidden markov models on said signals, to recognize recognizing predefined gestures from patterns of said inertia signals and magnetic field signals,
obtaining an output signal if a predefined pattern has been recognized,
mapping said output signal to a predefined force feedback output signal, and
generating a predefined force feedback signal at said motion-input device.

33. Computer program product capable of generating an input for a computer device from 3-D accelerator and 3-D compass sensors, comprising program code sections for carrying out the steps of anyone of claims 28 to 32, when said program is run on a controller, processor-based device, a computer, a microprocessor based device, a terminal, a network device, a mobile terminal or a mobile communication enabled terminal.

34. Computer program product for executing a method capable of generating an input for a computer device from 3-D accelerator and 3-D compass sensors, comprising program code sections stored on a machine-readable medium for carrying out the steps of anyone of claims 28 to 32, when said program product is run on a controller, processor-based device, a computer, a microprocessor based device, a terminal, a network device, a mobile terminal, or a mobile communication enabled terminal.

35. Software tool capable of generating an input for a computer device from 3-D accelerator and 3-D compass sensors, comprising program portions for carrying out the operations of any one of the claims 28 to 32, when said program is implemented in a computer program for being executed on a controller, processor-based device, a microprocessor based device, processing device, a terminal device, a network device, a mobile terminal, or a mobile communication enabled terminal.

36. Computer data signal embodied in a carrier wave and representing instructions, which when executed by a processor cause the steps of anyone of claims 28 to 32 to be carried out.
